(19) United States
(12) Patent Application Publication
(10) Pub. No.: US 2017/0155708 A1
(43) Pub. Date: Jun. 1, 2017

(54) SOFTWARE DEFINED NETWORKING SYSTEM AND NETWORK CONNECTION ROUTING METHOD THEREOF

(71) Applicant: Institute For Information Industry, Taipei (TW)

(72) Inventors: Po-Wen CHI, Taipei City (TW); Yu-Hsiang LIN, Taoyuan City (TW); Cheng-Wei HU, Xihu Township (TW); Yung-Chung WANG, Taipei City (TW)

(21) Appl. No.: 14/963,416

(22) Filed: Dec. 9, 2015

(30) Foreign Application Priority Data
Nov. 27, 2015 (TW) 104139619

(51) Int. Cl. H04L 29/08; H04L 12/947; H04L 12/28; H04L 29/12

(52) U.S. Cl. CPC H04L 67/1004; H04L 61/2007; H04L 49/25; H04L 12/2854

(57) ABSTRACT

A software defined networking (SDN) system and network connection routing method thereof are provided. The SDN system includes an SDN controlling server and an SDN switch. The SDN switch receives client network packets from a client device and transmits the client network packets to the SDN controlling server. The SDN controlling server determines a connection route of the client device according to the client network packets and server loading information. The SDN controlling server transmits the connection route to the SDN switch. The SDN switch stores the connection route and transmits the client network packets to one of servers based on the connection route.

### PRIORITY

This application claims priority to Taiwan Patent Application No. 104139619 filed on Nov. 27, 2015, which is hereby incorporated by reference in its entirety.

### FIELD

The present invention relates to a software defined networking (SDN) system and a network connection routing method thereof. More particularly, the present invention relates to an SDN system and a network connection routing method thereof for balancing the network load.

### BACKGROUND

When different client devices in the conventional network architecture desire to access network resources of a serving end via a network, a plurality of servers may be used at the serving end to share the accessing load so that the accessing efficiency can be maintained by avoiding the bottleneck in accessing performance caused by using a single server, Coordination among the plurality of servers is accomplished mainly by a load balancer, and load balancers may generally be classified into load balancers of the bridge mode, load balancers of the route mode and load balancers of the address resolution protocol mode.

Specifically, load balancers of the bridge mode and the route mode are disposed at a front end of the serving end to receive accessing requests from different client devices, translate Internet Protocol (IP) addresses for the different client devices, and forward network packets of the different client devices to different servers accordingly. In this way, sharing of the network resource accessing load can be achieved.

However, in the process of using a load balancers of the bridge mode or the route mode for coordination, data flows of all the client devices must be processed by the load balancer and header replacement must be made by the load balancer for IP addresses of the network packages of the client devices. Therefore, the processing capability of the load balancer becomes the bottleneck in performance.

On the other hand, load balancers of the address resolution protocol mode are mainly disposed at a back end of the serving end and share a same IP address as the different servers, and the connection request and packets from the client devices are forwarded by a router located at the front end of the serving end. The function of the load balancers is that, in case that all the servers have deactivated the address resolution protocol function, the address resolution protocol table of the router can be updated by the load balancers according to load conditions of the different servers directly so that the network resource accessing load can be shared by the servers directly according to the load conditions of the servers.

However, because the load balancers of the address resolution protocol mode that are used for coordination are disposed at the back end of the serving end and only function to update the address resolution protocol table according to the load conditions of the server, it is impossible to allocate at the front end the network resource accessing load from different client devices and this significantly degrades the flexibility of the routing.

Accordingly, an urgent need exists in the art to make an improvement on the shortcomings of the conventional network load balancing mechanisms to increase the load balancing efficiency and keep the flexibility of the routing.

### SUMMARY

The disclosure includes a network connection routing method for a software defined networking (SDN) system. The SDN system comprises an SDN controlling server and a first SDN switch. The SDN controlling server connects with the first SDN switch. The first SDN switch connects with a plurality of servers and connects with a client device via a wide area network (WAN). The SDN controlling server is stored with server loading information of the servers. The network connection routing method comprises the following steps of: (a) enabling the first SDN switch to receive a first client network packet from the client device and transmit the first client network packet to the SDN controlling server; (b) enabling the SDN controlling server to determine a connection route of the client device according to the first client network packet and the server loading information; (c) enabling the SDN controlling server to transmit the connection route to the first SDN switch; and (d) enabling the first SDN switch to store the connection route and transmit the first client network packet to a first server among the servers according to the connection route.

The disclosure includes an SDN system, which comprises an SDN controlling server and a first SDN switch. The SDN controlling server connects with the first SDN switch. The first SDN switch connects with a plurality of servers and connects with a client device via a WAN. The SDN controlling server stores server loading information of the plurality of servers. The first switch receives a first client network packet from the client device and transmits the first client network packet to the SDN controlling server. The SDN controlling server determines a connection route of the client device according to the first client network packet and the server loading information, and transmits the connection route to the first SDN switch. The first SDN switch stores the connection route and transmits the first client network packet to a first server among the servers according to the connection route.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of an SDN system according to a first embodiment of the present invention;

FIG. 1B is a block diagram of an SDN controlling server according to the first embodiment of the present invention;

FIG. 1C is a block diagram of a first SDN switch according to the first embodiment of the present invention;

FIG. 2A is a schematic view of an SDN system according to a second embodiment of the present invention;

FIG. 2B is a schematic view of a connection route according to the second embodiment of the present invention;

FIG. 3A is a schematic view of an SDN system according to a third embodiment of the present invention;

FIG. 3B is a schematic view of a connection route according to the third embodiment of the present invention;

FIG. 4A is a schematic view of an SDN system according to a fourth embodiment of the present invention;

FIG. 4B is a block diagram of a second SDN switch according to the fourth embodiment of the present invention;

FIG. 4C is a block diagram of a third SDN switch according to the fourth embodiment of the present invention;

FIG. 4D is a schematic view of a connection route according to the fourth embodiment of the present invention;

FIG. 5A is a schematic view of an SDN system according to a fifth embodiment of the present invention;

FIG. 5B is a schematic view of a connection route according to the fifth embodiment of the present invention;

FIG. 6 is a flowchart diagram of a network connection routing method according to a sixth embodiment of the present invention;

FIG. 7 is a flowchart diagram of a network connection routing method according to a seventh embodiment of the present invention;

FIG. 8 is a flowchart diagram of a network connection routing method according to an eighth embodiment of the present invention; and

FIG. 9 is a flowchart diagram of a network connection routing method according to a ninth embodiment of the present invention.

### DETAILED DESCRIPTION

In the following description, the present invention will be explained with reference to example embodiments thereof. However, these example embodiments are not intended to limit the present invention to any specific example, embodiment, environment, applications or particular implementations described in these example embodiments. Therefore, description of these example embodiments is only for purpose of illustration rather than to limit the present invention.

It should be appreciated that, in the following embodiments and the attached drawings, elements unrelated to the present invention are omitted from depiction; and dimensional relationships among individual elements in the attached drawings are illustrated only for ease of understanding, but not to limit the actual scale.

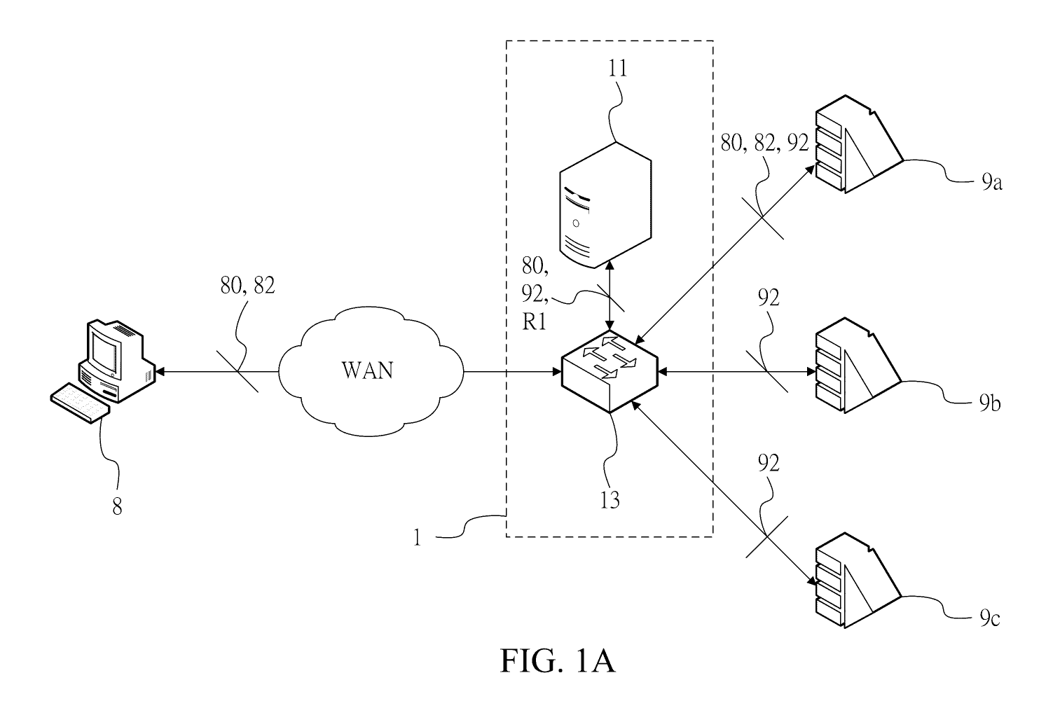

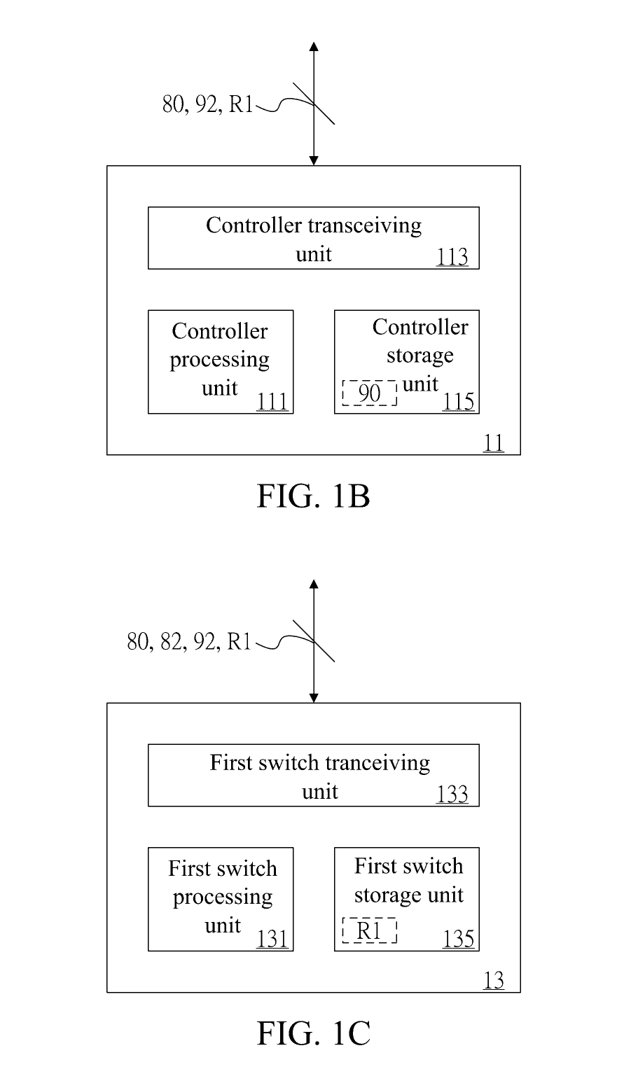

Please refer to FIG. 1A to FIG. 1C. FIG. 1A is a schematic view of a software defined networking (SDN) system 1 according to a first embodiment of the present invention, where the SDN system 1 comprises an SDN controlling server 11 and a first SDN switch 13. FIG. 1B is a block diagram of the SDN controlling server 11 according to the first embodiment of the present invention, where the SDN controlling server 11 comprises a controller processing unit 111, a controller transceiving unit 113 and a controller storage unit 115. FIG. 1C is a block diagram of the first SDN switch 13 according to the first embodiment of the present invention, where the first SDN switch 13 comprises a first switch processing unit 131, a first switch transceiving unit 133 and a first switch storage unit 135.

As shown, the SDN controlling server 11 connects with the first SDN switch 13. The first SDN switch 13 connects with a plurality of servers 9a˜9c and connects with a client device 8 via a wide area network (WAN). The controller storage unit 115 of the SDN controlling server 11 stores a piece of server loading information 90 of the servers 9a˜9c therein. The server loading information 90 records load conditions of the servers 9a˜9c. Interactions between the SDN system 1 and devices thereof will be further described hereinbelow.

Firstly, the client device 8 which desires to access network resources of the servers 9a˜9c transmits a first client network packet to the first SDN switch 13 via the WAN. Then, the first switch transceiving unit 133 of the first SDN switch 13 receives the first client network packet 80 from the client device 8.

Because the first SDN switch 13 has not processed any packet of the client device 8 before, the first switch processing unit 131 of the first SDN switch 13 firstly transmits the first client network packet 80 to the SDN controlling server 11 via the first switch transceiving unit 133 after determining that there is no corresponding packet processing rules stored therein. Then after the first client network packet 80 is received by the controller transceiving unit 113 of the SDN controlling server 11, the controller processing unit 111 determines a connection route R1 of the client device according to the first client network packet 80 and the server loading information 90.

It shall be particularly appreciated that, the server 9a has a light load as recorded in the server loading information 90 in the first embodiment, so the connection route R1 determined by the controller processing unit 111 of the SDN controlling server 11 is mainly to forward data of the client device 8 to the server 9a.

Next, the controller transceiving unit 113 of the SDN controlling server 11 transmits to the first SDN switch 13 the connection route R1, which is then received by the first switch transceiving unit 133 of the first SDN switch 13 and stored in the switch storage unit 135. Accordingly, the first switch processing unit 131 of the first SDN switch 13 can directly transmit the first client network packet 80 to the server 9a via the first switch transceiving unit 133 according to the connection route R1.

Thus, as the connection route R1 has been determined by the SDN controlling server 11 according to the load conditions of the servers 9a˜9c and the information of the client device 8 and stored in the SDN switch 13, subsequent network packets transmitted by the client device 8 can be forwarded by the SDN switch 13 directly to the server 9a according to the connection route R1.

For example, when subsequently a second client network packet 82 is received by the first switch transceiving unit 133 of the first SDN switch 13 from the client device 8, the first switch processing unit 131 of the first SDN switch 13 firstly determines that the connection route R1 corresponding to the client device 8 has already been stored in the switch storage unit 135 and then directly transmits the second client network packet 82 to the server 9a via the first switch transceiving unit 133 according to the connection route R1. In this way, the time of forwarding each packet can be reduced to significantly increase the operation efficiency.

It shall be particularly appreciated that, the controller transceiving unit 1113 of the SDN controller 11 may receive a plurality of pieces of server information 92 from the servers 9a˜9c at regular times in the first embodiment, so the controller processing unit 111 of the SDN server 11 can update the server loading information 90 according to the server information 92 to keep the server loading information updated Here, the SDN controller 1 may receive the server information 92 directly via the connection with the servers 9a˜9c, or receive the server information 92 of the servers 9a˜9c via the first SDN switch 13.

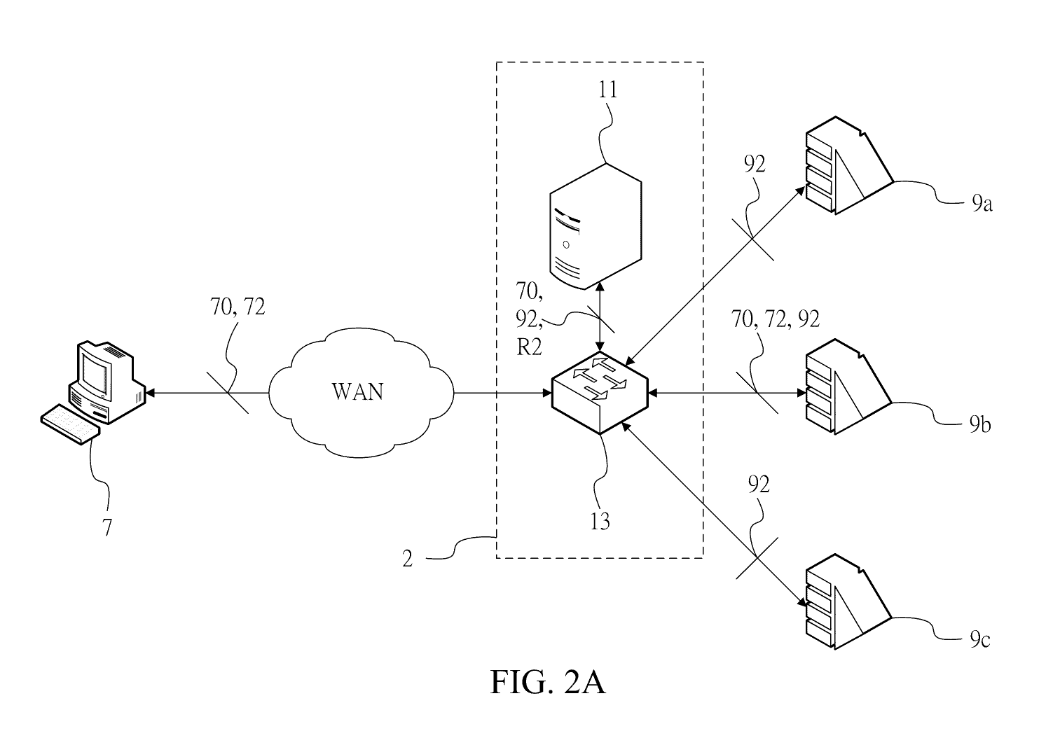

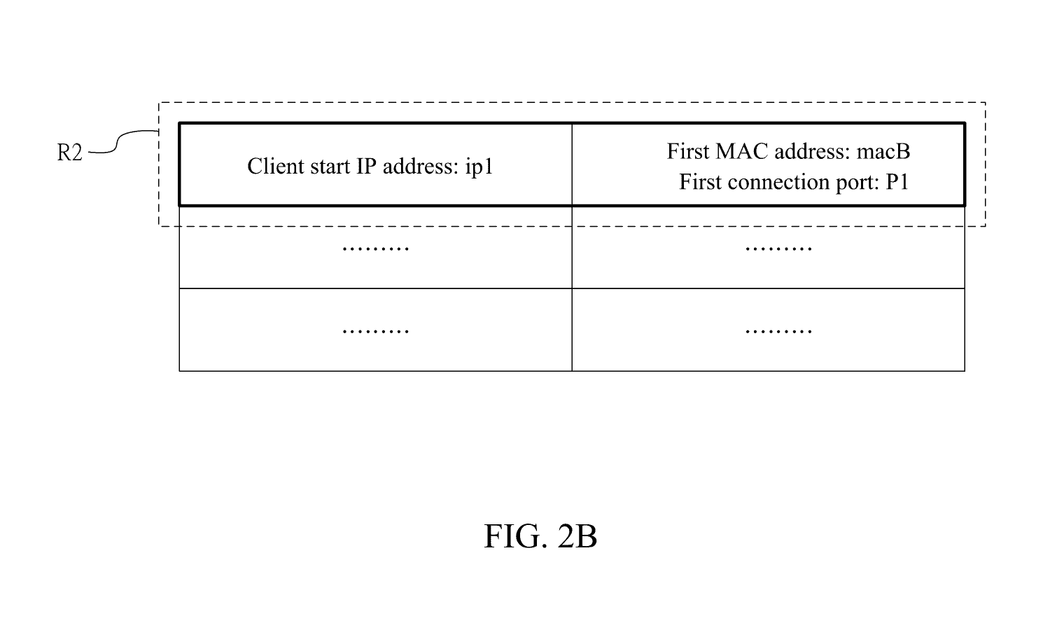

Please refer to FIG. 2A, which is a schematic view of an SDN system 2 according to a second embodiment of the present invention The second embodiment is similar to the first embodiment in terms of the network architecture, so elements bearing the same reference numerals also have the same functions and will not be described again herein. The second embodiment is mainly to further describe details of the connection route.

Similarly, the client device 7 which desires to access network resources of the servers 9a˜9c transmits a first client network packet 70 to the first SDN switch 13 via the WAN. Then the first client network packet 80 is received by the first switch transceiving unit 133 of the first SDN switch 13 from the client device 7. Here, the first client network packet 70 has a client start IP address ip1.

Because the first SDN switch 13 has not stored the packet processing rule of the client device 7 therein, the first SDN switch 13 firstly transmits the first client network packet 70 to the SDN controlling server 11 via the first switch transceiving unit 133. After the first client network packet 70 is received by the controller transceiving unit 113 of the SDN controlling server 11, the controller processing unit 111 determines a connection route R2 of the client device 7 according to the client start IP address ip1 of the first client network packet 70 and the server loading information 90.

Please refer to FIG. 2B together, which is a schematic view of the connection route R2 according to the second embodiment of the present invention. In detail, because the server 9b has a light load as recorded in the server loading information 90 in the second embodiment, the connection route R2 determined by the controller processing unit 111 of the SDN controller server 11 is mainly to forward data of the client device 7 to the server 9b. Further speaking, as shown in FIG. 2B, the connection route R2 records a correspondence relationship of the client start IP address ip1 with a Media Access Control (MAC) address macB of the server 9b and a first connection port P1.

Next, the controller transceiving unit 113 of the SDN controlling server 11 transmits to the first SDN switch 13 the connection route R2, which is then received by the first switch transceiving unit 133 of the first SDN switch 13 and stored in the switch storage unit 135. Accordingly, the first switch processing unit 131 of the first SDN switch 13 can directly transmit the first client network packet 70 to the server 9b via the first switch transceiving unit 133 according to the connection route R2.

Similarly, as the connection route R2 has been determined by the SDN controlling server 11 according to the load conditions of the server 9a˜9c and the information of the client device 7 and stored in the SDN switch 13 in the second embodiment, subsequent network packets transmitted by the client device 7 can be directly forwarded by the SDN switch 13 to the server 9b according to the connection route R2.

For example, when subsequently a second client network packet 72 is received by the first switch transceiving unit 133 of the first SDN switch 13 from the client device 7, the first switch processing unit 131 of the first SDN switch 13 firstly determines that the connection route R2 corresponding to the client device 7 has already been stored in the switch storage unit 135 according to the client IP address ip1 of the second client network packet 72.

Next, the first switch processing unit 131 of the first SDN switch 13 can transmit the second client network packet 72 to the server 9b directly via the first switch transceiving unit 133 according to the correspondence relationship of the client start IP address ip1 with the MAC address macB of the server 9b and the first connection port P1 that is recorded in the connection route R2.

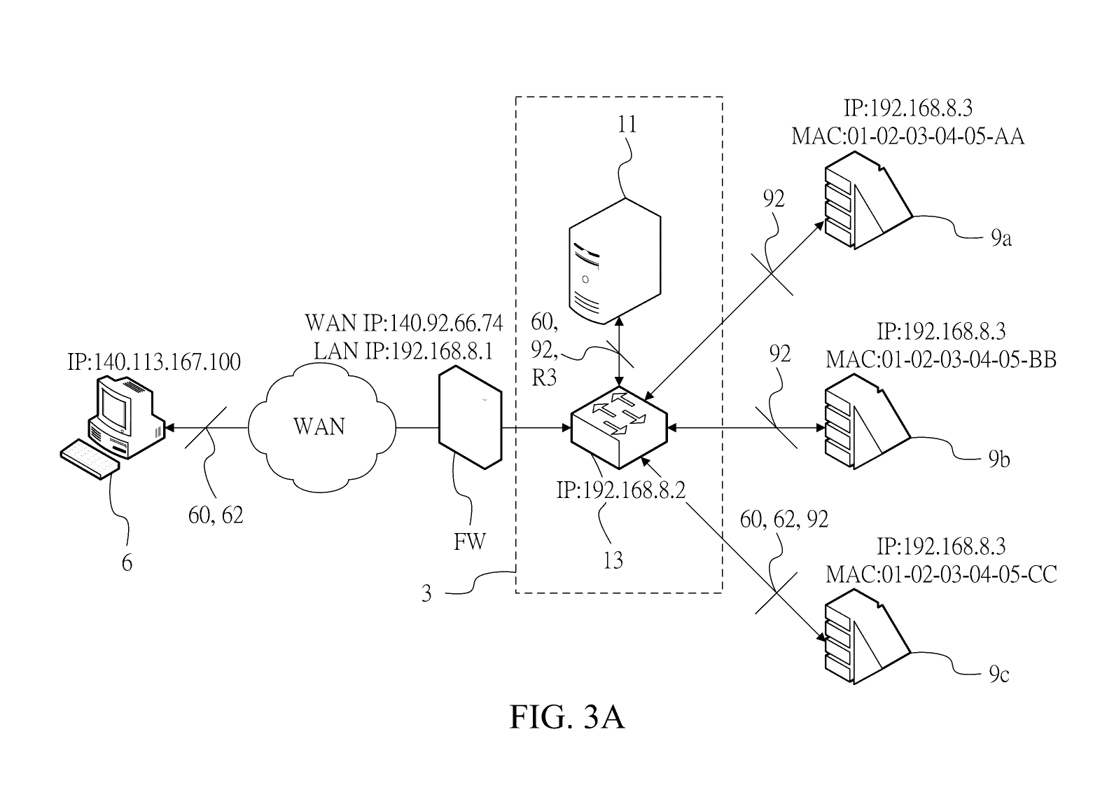

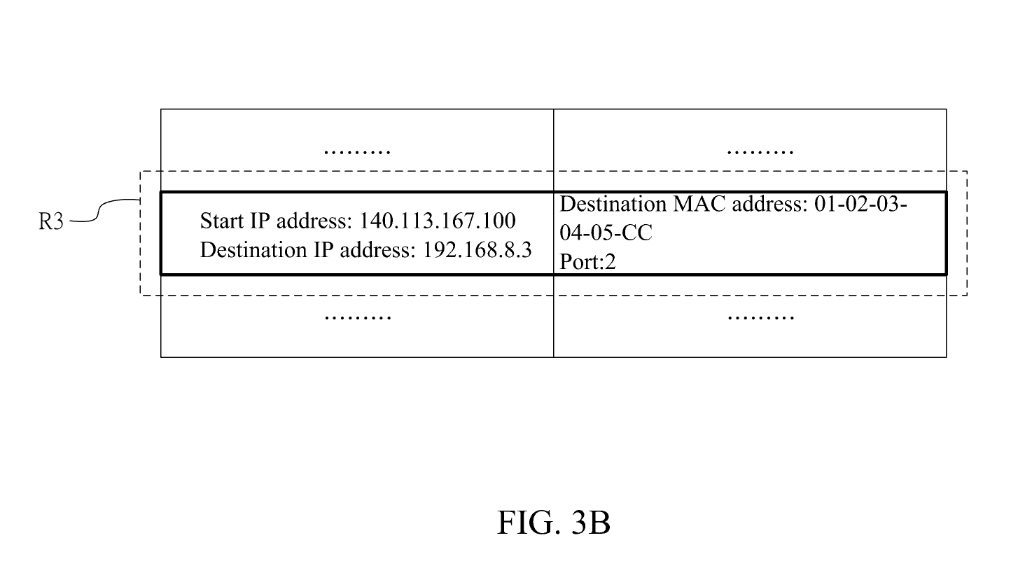

Please refer to FIG. 3A, which is a schematic view of an SDN system 3 according to a third embodiment of the present invention. The third embodiment is similar to the previous embodiments in terms of the network architecture, so elements bearing the same reference numerals also have the same functions and will not be described again herein. The third embodiment is mainly to illustrate details of the connection route in a generic manner.

Similarly, the client device 6 (IP address: 140.113.167.100) which desires to access network resources of the serving end (IP address: 140.92.66.74) transmits a first client network packet 60 to the serving end via the WAN. Here, the serving end of the third embodiment further comprises a firewall FW (of which the exterior network IP address is just the serving end IP address, and the interior network address is 192.168.8.1).

Because the packet must finally be processed by the servers 9a˜9c (the interior network IP address shared: 192.168.8.3, respective MAC addresses: 01-02-03-04-05-AA, 01-02-03-04-05-BB, 01-02-03-04-05-CC), the destination IP address of the first client network packet 60 must be translated into the common interior network IP address shared by the servers 9a˜9c by the firewall FW.

Then, because the firewall FW belongs to a same LAN domain as the first SDN switch 13, the firewall FW may forward the first client network packet 60 to the first SDN switch 13 so that the subsequent route of the packet is determined by the first SDN switch 13. Because the first SDN switch 13 has not stored the packet processing rule of the client device 6 therein, the first SDN switch 13 firstly transmits the first client network packet 60 to the SDN controlling server 11 via the first switch transceiving unit 133.

After the first client network packet 60 is received by the controller transceiving unit 113 of the SDN controlling server 11, the controller processing unit 111 determines a connection route R3 of the client device 6 according to the start IP address (i.e., 140.113.167.100) of the first client network packet 60 and the server loading information 90.

Please refer to FIG. 3B together, which is a schematic view of the connection route R3 according to the third embodiment of the present invention. In detail, because the server 9c has a light load as recorded in the server loading information 90 in the third embodiment, the connection route R3 determined by the controller processing unit 111 of the SDN controller server 11 is mainly to forward data of the client device 6 to the server 9c.

Further speaking, as shown in FIG. 3B, the connection route R3 records a correspondence relationship of the start IP address (i.e., 140.113.167.100) and the destination IP address (i.e., 192.168.8.3) with a connection port Port:2 used by the first SDN switch 13 to connect with the server 9c and an MAC address 01-02-03-04-05-CC of the server 9c.

Next, the controller transceiving unit 113 of the SDN controlling server 11 transmits to the first SDN switch 13 the connection route R3, which is then received by the first switch transceiving unit 133 of the first SDN switch 13 and stored in the switch storage unit 135. Accordingly, the first switch processing unit 131 of the first SDN switch 13 can transmit the first client network packet 60 to the server 9c directly via the first switch transceiving unit 133 according to the connection route R3.

Similarly, as the connection route R3 has been determined by the SDN controlling server 11 according to the load conditions of the server 9a˜9c and the information of the client device 6 and stored in the SDN switch 13 in the third embodiment, subsequent network packets transmitted by the client device 6 can be directly forwarded by the SDN switch 13 to the server 9c according to the connection route R3.

For example, when subsequently a second client network packet 62 is transmitted by the client device 6 to the serving end, the firewall FW also firstly forwards the second client network packet 62 to the first SDN switch 13. At this time, the second client network packet 62 has the start IP address 140.113.167.100 and the destination IP address 192.168.8.3. Then the first switch processing unit 131 of the first SDN switch 13 can determine that the connection route R3 corresponding to the client device 6 has already been stored in the switch storage unit 135.

Next, the first switch processing unit 131 of the first SDN switch 13 can transmit the second client network packet 62 to the server 9c directly via the first switch transceiving unit 133 according to the correspondence relationship of the start IP address 140.113.167.100 and the destination IP address 192.168.8.3 with the connection port Port:2 of the first SDN switch 13 and the MAC address 01-02-03-04-05-CC of the server 9c that is recorded in the connection route R3.

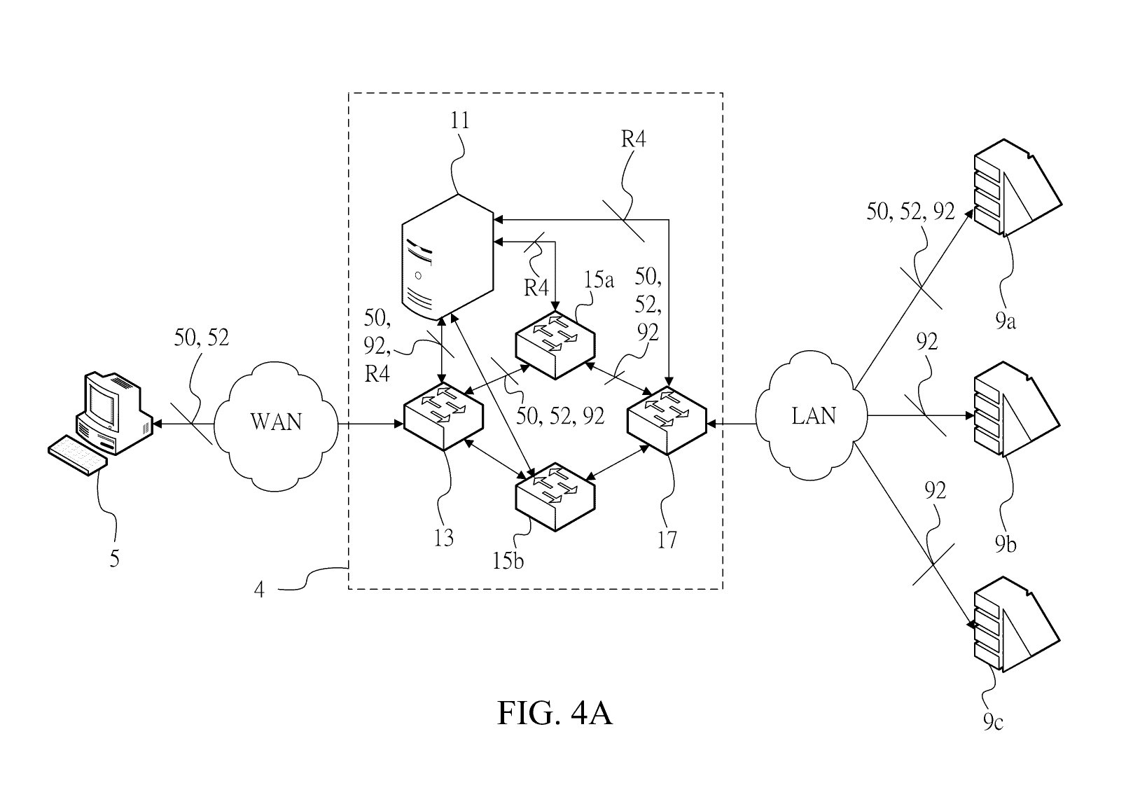

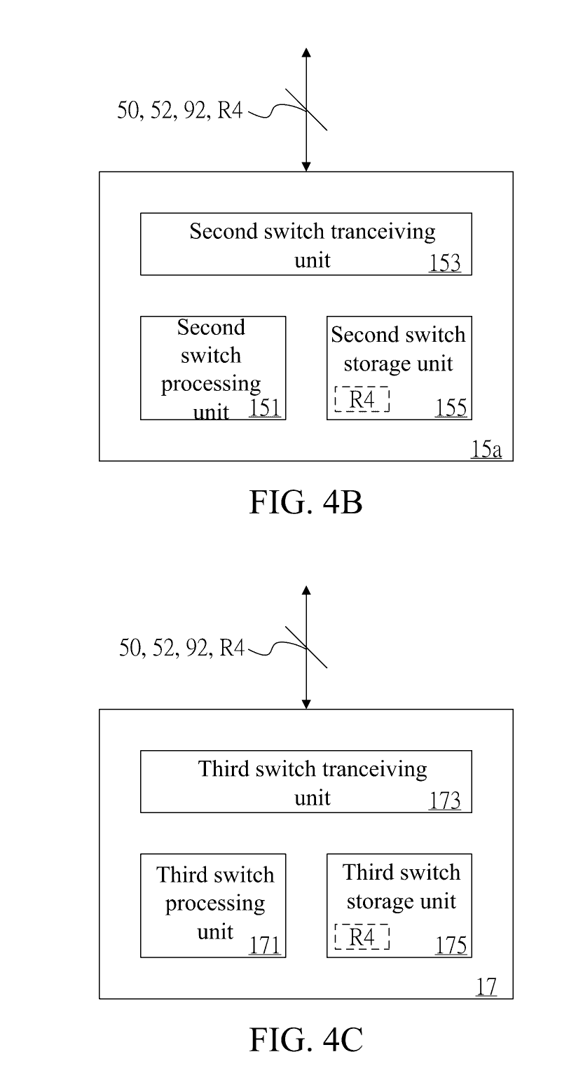

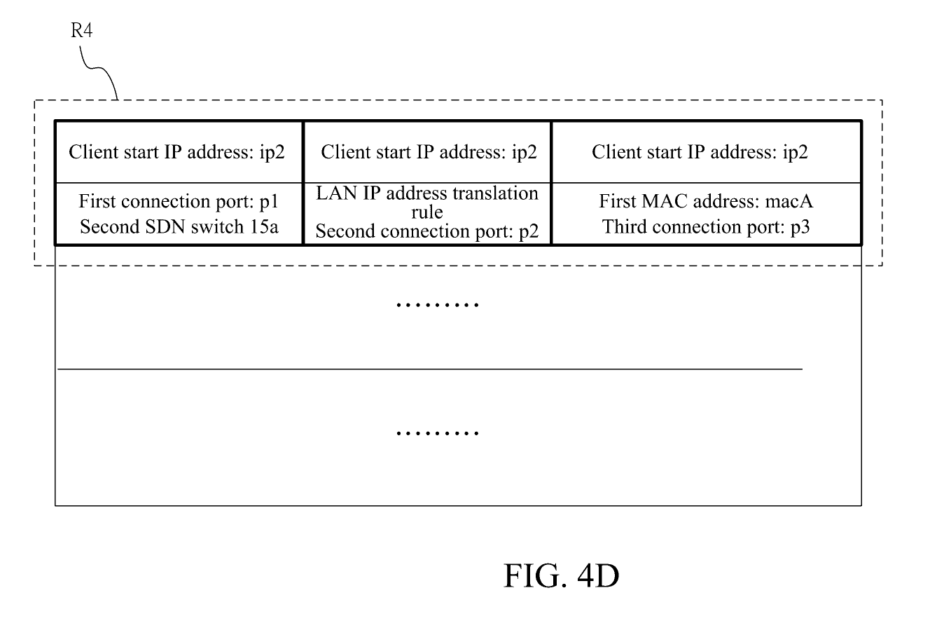

Please refer to FIGS. 4A to 4C. FIG. 4A is a schematic view of an SDN system 4 according to a fourth embodiment of the present invention. The SDN system 4 further comprises at least one second SDN switch 15 (including 15a and 15b) and a third SDN switch 17. FIG. 4B is a block diagram of the second SDN switch 15a according to the fourth embodiment of the present invention. The second SDN switch 15a comprises a second switch processing unit 151, a second switch transceiving unit 153 and a second switch storage unit 155.

FIG. 4C is a schematic view of the third SDN switch 17 according to the fourth embodiment of the present invention. The third SDN switch 17 comprises a third switch processing unit 171, a third switch transceiving unit 173 and a third switch storage unit 175. The second SDN switch 15a˜15b and the third SDN switch 17 connect with the SDN controller 11, and the first SDN switch 13, the second SDN switch 15a˜15b and the third SDN switch 17 belong to a same LAN domain as each other but belong to different LAN domains from the servers 9a˜9c. The servers 9a˜9c share a common server IP address sip.

Specifically, the client device 5 which desires to access network resources of the servers 9a˜9c transmits a first client network packet 50 to the first SDN switch 13 via the WAN. Then, the first client network packet 50 is received by the switch transceiving unit 133 of the first SDN switch 13 from the client device 5. The first client network packet 50 comprises a client start IP address ip2.

Because the first SDN switch 13 has not processed any packet of the client device 5 before, the first switch processing unit 131 of the first SDN switch 13 firstly transmits the first client network packet 50 to the SDN controlling server 11 via the first switch transceiving unit 133 after determining that there is no corresponding packet processing rule. Then after the first client network packet 50 is received by the controller transceiving unit 113 of the SDN controlling server 11, the controller processing unit 111 determines a connection route R4 of the client device according to the client start address ip2 and the server loading information 90.

It shall be particularly appreciated that, the server 9a has a light load as recorded in the server loading information 90 in the fourth embodiment, so the connection route R4 determined by the controller processing unit 111 of the SDN controlling server 11 is mainly to forward data of the client device 5 to the server 9a. Here, because the SDN switches are located in different LAN domains from the servers, a plurality of second SDN switches are used in the fourth embodiment to translate the interior network destination IP addresses of network packets.

Further speaking, please refer to FIG. 4D together, which is a schematic view of the connection route R4 according to the fourth embodiment of the present invention. The connection route R4 mainly records a first correspondence relationship of the client start IP address ip2 with a first connection port p1 of the second SDN switch 15a, a second correspondence relationship between an LAN IP address translation rule corresponding to the client start IP address ip2 and a second connection port p2 of the third SDN switch 17, and a third correspondence relationship of the client start IP address ip2 with an MAC address macA of the server 9a and a third connection port p3.

Next, the controller transceiving unit 113 of the SDN controlling server 11 transmits the first correspondence relationship, the second correspondence relationship and the third correspondence relationship of the connection route R4 to the first SDN switch 13, the second SDN switch 15a and the third SDN switch 17 respectively. It shall be particularly emphasized that, the LAN IP address translation of the network packets is accomplished mainly by the second SDN switch 15a in the fourth embodiment, but in other embodiments, the SDN controlling server 11 may also appoint the second SDN switch 15b to accomplish this step for purpose of sharing the packet processing load.

After the first correspondence relationship of the connection route R4 is received by the first switch transceiving unit 133 of the first SDN switch 13, the first correspondence relationship of the connection route R4 is stored by the first switch storage unit 135. Accordingly, the first switch processing unit 131 of the first SDN switch 13 can transmit the first client network packet 50 to the second SDN switch 15a directly via the first switch transceiving unit 133 according to the first correspondence relationship of the connection route R4.

On the other hand, after the second correspondence relationship of the connection route R4 is received by the second switch transceiving unit 153 of the second SDN switch 15a, the second correspondence relationship of the connection route R4 is stored by the second switch storage unit 155. Accordingly, after the first client network packet 50 is received by the second switch transceiving unit 153 of the second SDN switch 15a, the second switch processing unit 151 can translate a client destination IP address ip3 of the first client network packet 50 into the LAN server IP address sip of the server 9a according to the LAN IP address translation rule of the second correspondence relationship, and transmit the first client network packet 50 to the third SDN switch 17 directly via the second switch transceiving unit 153.

After the third correspondence relationship of the connection route R4 is received by the third switch transceiving unit 173 of the third SDN switch 17, the third correspondence relationship of the connection route R4 is stored by the third switch storage unit 175. Accordingly, after the first client network packet 50 is received by the third switch transceiving unit 173 of the third SDN switch 17, the third switch processing unit 171 of the third SDN switch 17 can transmit the first client network packet 50 to the server 9a located in a different LAN directly via the third switch transceiving unit 173 according to the third correspondence relationship of the connection route R4.

Similarly, after the connection route R4 has been determined by the SDN controlling server 11 according to the load conditions of the servers 9a˜9c and the information of the client device 5 and stored in the SDN switches 13, 15 and 17, subsequent network packets (e.g., a second client network packet 52) transmitted by the client device 5 can be forwarded by the SDN switches 13, 15 and 17 to the server 9a directly according to the connection route R4.

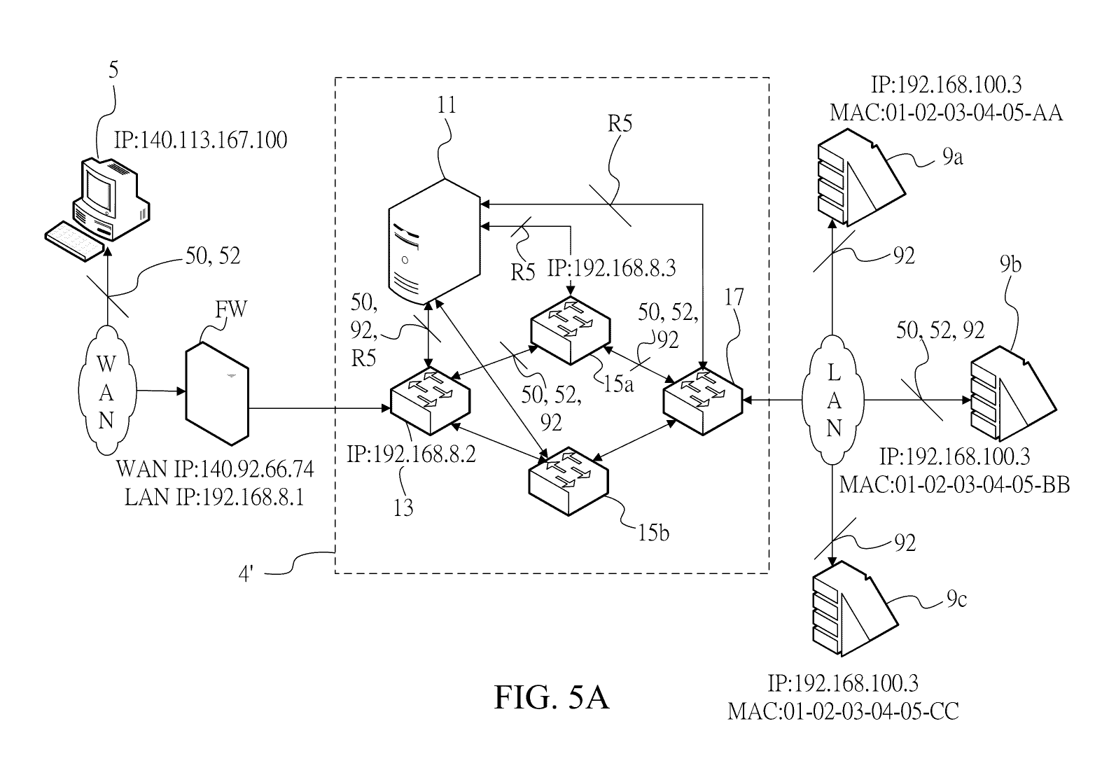

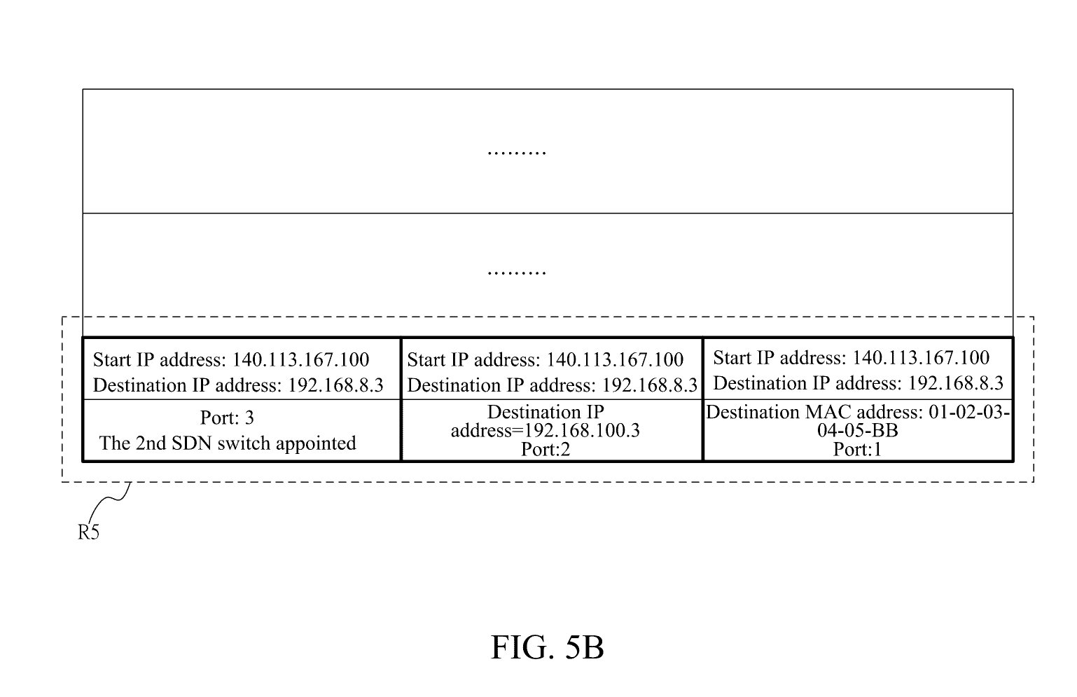

Please refer to FIG. 5A, which is a schematic view of an SDN system 4′ according to a fifth embodiment of the present invention. The fifth embodiment is similar to the fourth embodiment in terms of the network architecture, so elements bearing the same reference numerals also have the same functions and will not be described again herein. The fifth embodiment is mainly to illustrate details of the connection route in a generic manner.

Similarly, the client device 5 (IP address: 140.113.167.100) which desires to access network resources of the serving end (IP address: 140.92.66.74) transmits a first client network packet 50 to the serving end via the WAN. Here, the serving end of the fifth embodiment also comprises a firewall FW (of which the exterior network IP address is just the serving end IP address, and the interior network address is 192.168.8.1).

Because packet header replacement must be firstly made by the second SDN switches 15a˜15b when being transmitted between different LAN domains, the destination IP address of the first client network packet 50 is firstly translated by the firewall FW into an interior network IP address (e.g., 192.168.8.3) of the load balancer. It shall be appreciated that, the function of the load balancer is accomplished by all the SDN switches in this embodiment.

Then, the firewall FW forwards the first client network packet 50 to the first SDN switch 13 so that the subsequent route of the packet is determined by the first SDN switch 13. Because the first SDN switch 13 has not stored the packet processing rule of the client device 5 therein, the first SDN switch 13 firstly transmits the first client network packet 50 to the SDN controlling server 11 via the first switch transceiving unit 133.

After the first client network packet 50 is received by the controller transceiving unit 113 of the SDN controlling server 11, the controller processing unit 111 determines a connection route R5 of the client device 5 according to the start IP address (i.e., 140.113.167.100) of the first client network packet 50 and the server loading information 90.

Please refer to FIG. 5B together, which is a schematic view of the connection route R5 according to the fifth embodiment of the present invention. In detail, because the server 9b has a light load as recorded in the server loading information 90 in the fifth embodiment, the connection route R5 determined by the controller processing unit 111 of the SDN controller server 11 is mainly to forward data of the client device 5 to the server 9b.

Further speaking, as shown in FIG. 5B, the connection route R5 records a first correspondence relationship of the start IP address (i.e., 140.113.167.100) and the destination IP address (i.e., 192.168.8.3) with a connection port Port:3 used by the first SDN switch 13 to connect with the second switch 15a, a second correspondence relationship of the start IP address and the destination IP address with the LAN IP address translation rule corresponding to the server IP (i.e., translating 192.168.8.3 into the server IP address 192.168.100.3 shared by the servers 9a˜9c belonging to another LAN) and a connection port Port:2 used by the second SDN switch 15a to connect with the third switch 17, and a third correspondence relationship of the start IP address with an MAC address 01˜02˜03˜04˜05-BB of the server 9b and a third connection port Port:1.

Next, the controller transceiving unit 113 of the SDN controlling server 11 transmits to the first SDN switch 13 the first correspondence relationship of the connection route R5, which is then received by the first switch transceiving unit 133 of the first SDN switch 13 and stored in the switch storage unit 135.

Accordingly, the first switch processing unit 131 of the first SDN switch 13 can directly transmit the first client network packet 50 to the second SDN switch 15a via the first switch transceiving unit 133 and through the connection port Port:3 according to the first correspondence relationship of the connection route R5.

On the other hand, after the second correspondence relationship of the connection route R5 is received by the second switch transceiving unit 153 of the second SDN switch 15a, the second correspondence relationship of the connection route R5 is stored by the second switch storage unit 155. Accordingly, after the first client network packet 50 is received by the second switch transceiving unit 153 of the second SDN switch 15a, the second switch processing unit 151 can translate the destination IP address of the first client network packet 50 into the server IP address (i.e., 192.168.100.3) of the server 9b belonging to another LAN according to the LAN IP address translation rule of the second correspondence relationship, and transmit the first client network packet 50 to the third SDN switch 17 directly via the second switch transceiving unit 153 and through the connection port Port:2.

After the third correspondence relationship of the connection route R5 is received by the third switch transceiving unit 173 of the third SDN switch 17, the third correspondence relationship of the connection route R5 is stored by the third switch storage unit 175. Accordingly, after the first client network packet 50 is received by the third switch transceiving unit 173 of the third SDN switch 17, the third switch processing unit 171 of the third SDN switch 17 can transmit the first client network packet 50 to the server 9b located in a different LAN directly via the third switch transceiving unit 173 and through the connection port Port:1 according to the third correspondence relationship of the connection route R5.

Similarly, after the connection route R5 has been determined by the SDN controlling server 11 according to the load conditions of the servers 9a˜9c and the information of the client device 5 and stored in the SDN switches 13, 15 and 17, subsequent network packets (e.g., a second client network packet 52) transmitted by the client device 5 can be forwarded by the SDN switches 13, 15 and 17 to the server 9b directly according to the connection route R5 in the aforesaid manner.

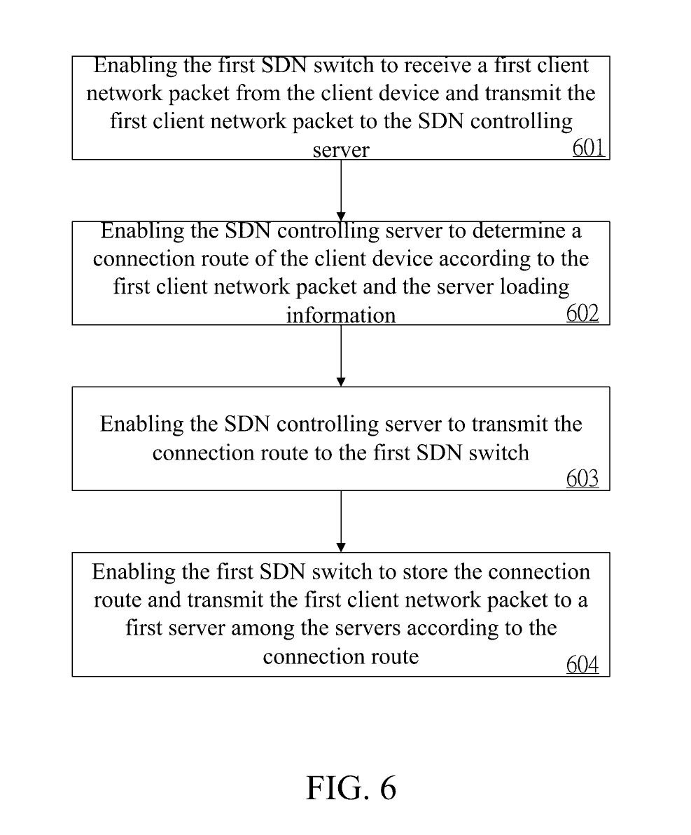

A sixth embodiment of the present invention is a network connection routing method, a flowchart diagram of which is shown in FIG. 6. The method of the sixth embodiment is for use in an SDN system (e.g., the SDN system of a previous embodiment) which comprises an SDN controlling server and a first SDN switch. The SDN controlling server connects with the first SDN switch. The first SDN switch connects with a plurality of servers and connects with a client device via a WAN. The SDN controlling server stores server loading information of the servers. Detailed steps of the sixth embodiment are described as follows.

Firstly, step 601 is executed to enable the first SDN switch to receive a first client network packet from the client device. Because the first SDN switch has not stored the packet processing rule of the client device therein, the first SDN switch transmits the first client network packet to the SDN controlling server. Step 602 is executed to enable the SDN controlling server to determine a connection route of the client device according to the first client network packet and the server loading information.

Then, step 603 is executed to enable the SDN controlling server to transmit the connection route to the first SDN switch. Finally, step 604 is executed to enable the first SDN switch to store the connection route and transmit the first client network packet to a first server among the servers according to the connection route.

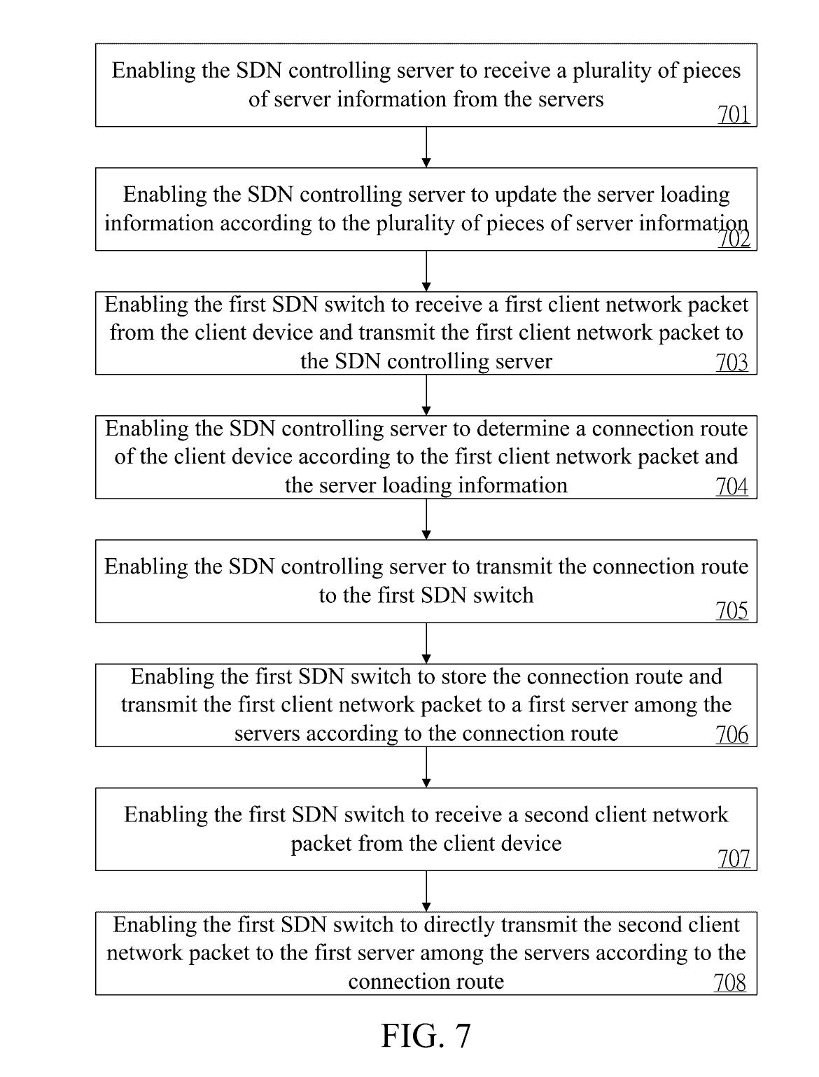

A seventh embodiment of the present invention is a network connection routing method, a flowchart diagram of which is shown in FIG. 7. The method of the seventh embodiment is for use in an SDN system (e.g., the SDN system of a previous embodiment) which comprises an SDN controlling server and a first SDN switch. The SDN controlling server connects with the first SDN switch. The first SDN switch connects with a plurality of servers and connects with a client device via a WAN. The SDN controlling server stores server loading information of the servers. Detailed steps of the seventh embodiment are described as follows.

Firstly, step 701 is executed to enable the SDN controlling server to receive a plurality of pieces of server information from the servers. Step 702 is executed to enable the SDN controlling server to update the server loading information according to the plurality of pieces of server information. Step 703 is executed to enable the first SDN switch to receive a first client network packet from the client device. Because the first SDN switch has not stored the packet processing rule of the client device therein, the first SDN switch transmits the first client network packet to the SDN controlling server.

Then, step 704 is executed to enable the SDN controlling server to determine a connection route of the client device according to the first client network packet and the server loading information. Step 705 is executed to enable the SDN controlling server to transmit the connection route to the first SDN switch. Step 706 is executed to enable the first SDN switch to store the connection route and transmit the first client network packet to a first server among the servers according to the connection route.

Afterwards, when a subsequent packet is to be transmitted by the client device, the subsequent packet can be transmitted directly according to the connection route. Step 707 is executed to enable the first SDN switch to receive a second client network packet from the client device. Finally, step 708 is executed to enable the first SDN switch to directly transmit the second client network packet to the first server among the servers according to the connection route.

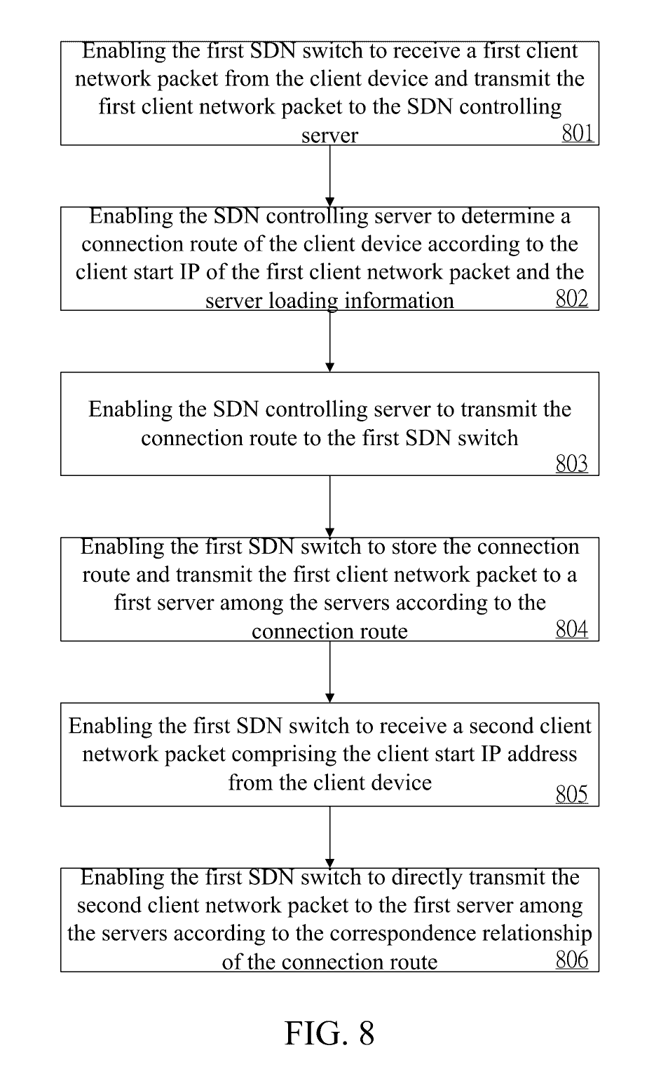

An eighth embodiment of the present invention is a network connection routing method, a flowchart diagram of which is shown in FIG. 8. The method of the eighth embodiment is for use in an SDN system (e.g., the SDN system of a previous embodiment) which comprises an SDN controlling server and a first SDN switch. The SDN controlling server connects with the first SDN switch. The first SDN switch connects with a plurality of servers and connects with a client device via a WAN. The SDN controlling server stores server loading information of the servers. The first SDN switch belongs to a same LAN domain as the plurality of servers. Detailed steps of the eighth embodiment are described as follows.

Firstly, step 801 is executed to enable the first SDN switch to receive a first client network packet from the client device. Here, the first client network packet comprises a client start IP address. Because the first SDN switch has not stored the packet processing rule of the client device therein, the first SDN switch transmits the first client network packet to the SDN controlling server.

Step 802 is executed to enable the SDN controlling server to determine a connection route of the client device according to the client start IP of the first client network packet and the server loading information. The connection route records a correspondence relationship of the client start IP address with a first MAC address of the first server and a first connection port.

Then, step 803 is executed to enable the SDN controlling server to transmit the connection route to the first SDN switch. Step 804 is executed to enable the first SDN switch to store the connection route and transmit the first client network packet to a first server among the servers according to the connection route.

Subsequently, when subsequent packets are to be transmitted by the client device, the subsequent packets can be transmitted directly according to the connection route. Step 805 is executed to enable the first SDN switch to receive a second client network packet comprising the client start IP address from the client device. Finally, step 806 is executed to enable the first SDN switch to directly transmit the second client network packet to the first server among the servers according to the correspondence relationship of the connection route.

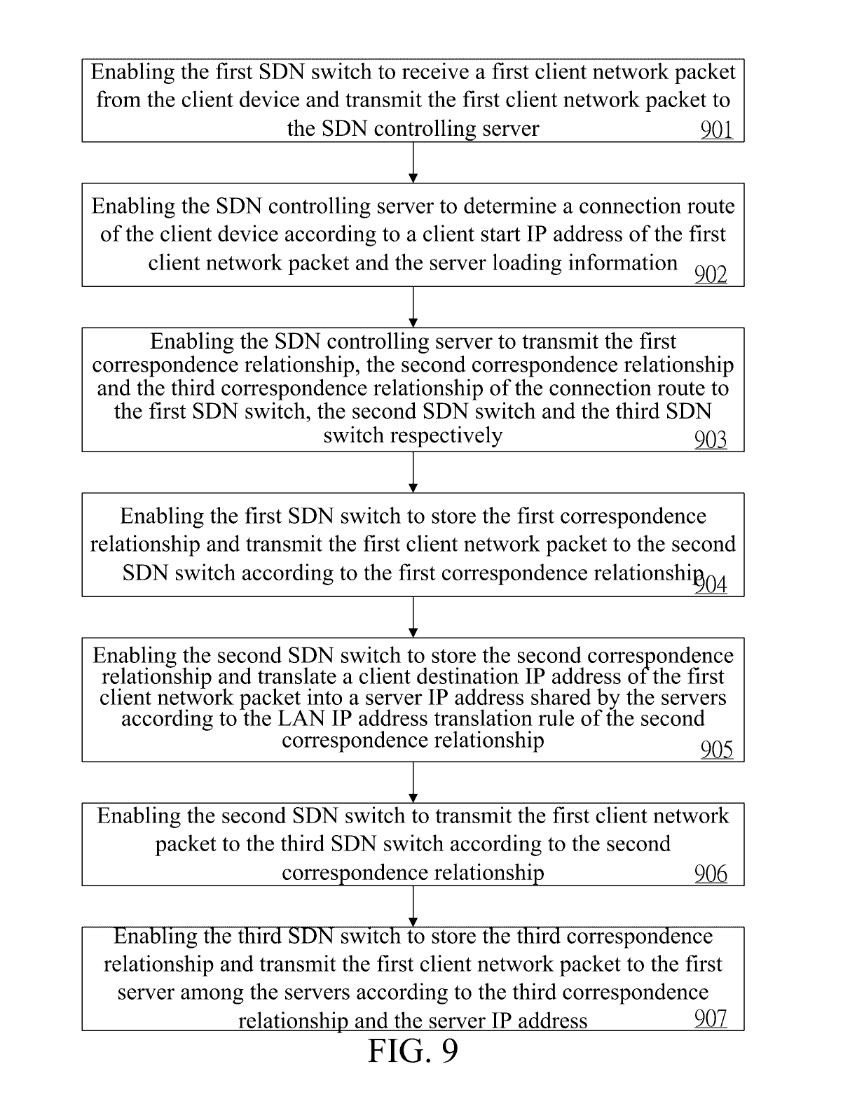

A ninth embodiment of the present invention is a network connection routing method, a flowchart diagram of which is shown in FIG. 9. The method of the ninth embodiment is for use in an SDN system (e.g., the SDN system of a previous embodiment) which comprises an SDN controlling server, a first SDN switch, a second SDN switch and a third SDN switch. The SDN controlling server connects with the first SDN switch, the second SDN switch and the third SDN switch.

The first SDN switch connects with a plurality of servers via the second SDN switch and the third SDN switch, and connects with a client device via a WAN. The first SDN switch, the second SDN switch and the third SDN switch belong to a same LAN domain, the first SDN switch and the servers belong to different LAN domains from each other. The SDN controlling server stores server loading information of the servers. Detailed steps of the ninth embodiment are described as follows.

Firstly, step 901 is executed to enable the first SDN switch to receive a first client network packet from the client device. Because the first SDN switch has not stored the packet processing rule of the client device therein, the first SDN switch transmits the first client network packet to the SDN controlling server. Step 902 is executed to enable the SDN controlling server to determine a connection route of the client device according to a client start IP address of the first client network packet and the server loading information.

It shall be particularly appreciated that, the connection route in the ninth embodiment records a first correspondence relationship of the client start IP address with a first connection port of the second SDN switch, a second correspondence relationship between an LAN IP address translation rule corresponding to the client start IP address and a second connection port of the third SDN switch, and a third correspondence relationship of the client start IP address with a first MAC address of the first server and a third connection port.

Then, step 903 is executed to enable the SDN controlling server to transmit the first correspondence relationship of the connection route, the second correspondence relationship of the LAN IP address translation rule and the third correspondence relationship to the first SDN switch, the second SDN switch and the third SDN switch respectively. Step 904 is executed to enable the first SDN switch to store the first correspondence relationship and transmit the first client network packet to the second SDN switch according to the first correspondence relationship.

Next, step 905 is executed to enable the second SDN switch to store the second correspondence relationship and translate a client destination IP address of the first client network packet into a server IP address shared by the servers according to the LAN IP address translation rule of the second correspondence relationship. Step 906 is executed to enable the second SDN switch to transmit the first client network packet to the third SDN switch according to the second correspondence relationship. Finally, step 907 is executed to enable the third SDN switch to store the third correspondence relationship and transmit the first client network packet to the first server among the servers according to the third correspondence relationship and the server IP address.

According to the above descriptions, the SDN system and the network connection routing method thereof according to the present invention can determine a subsequent network route according to load conditions of servers and the client device. Further speaking, the SDN architecture can make the network setting more convenient and allow for high flexibility in use and high expandability, and because the SDN controlling server directly uses the loading information of the servers to determine the network route and subsequently the SDN switch transmits the network packet directly according to the network route, the bottleneck in performance can be avoided in the centralized processing of packets. Thereby, an improvement can be made on the shortcomings of the conventional network load balancing mechanisms to increase the load balancing efficiency while still keeping the flexibility of the routing.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A network connection routing method for a software defined networking (SDN) system, the SDN system comprising an SDN controlling server and a first SDN switch, the SDN controlling server connecting with the first SDN switch, the first SDN switch connecting with a plurality of servers and connecting with a client device via a wide area network (WAN), and the SDN controlling server being stored with server loading information of the servers, the network connection routing method comprising:
(a) the first SDN switch receiving a first client network packet from the client device and transmit the first client network packet to the SDN controlling server;
(b) the SDN controlling server determining a connection route of the client device according to the first client network packet and the server loading information;
(c) the SDN controlling server transmitting the connection route to the first SDN switch; and
(d) the first SDN switch storing the connection route and transmit the first client network packet to a first server among the servers according to the connection route.

2. The network connection routing method of claim 1, further comprising the following before the step (a):
(a1) the SDN controlling server receiving a plurality of pieces of server information from the servers; and
(a2) the SDN controlling server updating the server loading information according to the plurality of pieces of server information.

3. The network connection routing method of claim 1, further comprising:
(e) the first SDN switch receiving a second client network packet from the client device; and
(f) the first SDN switch directly transmitting the second client network packet to the first server among the servers according to the connection route.

4. The network connection routing method of claim 1, wherein the first SDN switch and the servers belong to a same Local Area Network (LAN) domain, the first client network packet comprises a client start IP address, and the step (b) further comprises:
(b1) the SDN controlling server determining the connection route of the client device according to the client start IP address of the first client network packet and the server loading information, wherein the connection route records a correspondence relationship of the client start IP address with a first Media Access Control (MAC) address and a first connection port;
and wherein the step (d) further comprises:
(d1) the first SDN switch storing the connection route and transmit the first client network packet to a first server among the servers according to the correspondence relationship recorded in the connection route.

5. The network connection routing method of claim 4, further comprising the following after the step (d):
(e) the first SDN switch receiving a second client network packet from the client device, wherein the second client network packet comprises the client start IP address; and
(f) the first SDN switch directly transmitting the second client network packet to the first server among the servers according to the correspondence relationship of the connection route.

6. The network connection routing method of claim 1, wherein the SDN system further comprises a second SDN switch and a third SDN switch both connected to the SDN controlling server, the first SDN switch connects to the servers via the second SDN switch and the third SDN switch, the first SDN switch, the second SDN switch and the third SDN switch belong to a same LAN domain, the first SDN switch and the servers belong to different LAN domains from each other, the first client network packet comprises a client start IP address, and the step (b) further comprises:
(b1) the SDN controlling server determining the connection route of the client device according to the client start IP address of the first client network packet and the server loading information, wherein the connection route records a first correspondence relationship of the client start IP address with a first connection port of the second SDN switch, a second correspondence relationship between an LAN IP address translation rule corresponding to the client start IP address and a second connection port of the third SDN switch, and a third correspondence relationship of the client start IP address with a first MAC address of the first server and a third connection port;
wherein the step (c) further comprises:
(c1) the SDN controlling server transmitting the first correspondence relationship of the connection route to the first SDN switch;
(c2) the SDN controlling server transmitting the second correspondence relationship of the connection route to the second SDN switch;
(c3) the SDN controlling server transmitting the third correspondence relationship of the connection route to the third SDN switch;
and wherein the step (d) further comprises:
(d1) the first SDN switch storing the first correspondence relationship and transmit the first client network packet to the second SDN switch according to the first correspondence relationship;
(d2) the second SDN switch storing the second correspondence relationship and translate a client destination IP address of the first client network packet into a server IP address shared by the servers according to the LAN IP address translation rule of the second correspondence relationship;
(d3) the second SDN switch transmitting the first client network packet to the third SDN switch according to the second correspondence relationship; and
(d4) the third SDN switch storing the third correspondence relationship and transmit the first client network packet to the first server among the servers according to the third correspondence relationship and the server IP address.

7. A software defined networking (SDN) system, comprising:
an SDN controlling server, comprising:
a controller processing unit;
a controller transceiving unit; and
a controller storage unit, being stored with server load information of a plurality of servers;
a first SDN switch, connecting with the SDN controlling server and the servers and connecting with a client device via a WAN, and comprising:
a first switch processing unit;
a first switch transceiving unit;
a first switch storage unit;
wherein the first switch transceiving unit receives a first client network packet from the client device and transmits the first client network packet to the SDN controlling server; the controller processing unit determines a connection route of the client device according to the first client network packet and the server loading information, and transmits the connection route to the first SDN switch via the controller transceiving unit; the first switch storage unit stores the connection route; and the first switch processing unit transmits the first client network packet to a first server among the servers via the first switch transceiving unit according to the connection route.

8. The SDN system of claim 7, wherein the controller transceiving unit further receives a plurality of pieces of server information from the servers, and the controller processing unit further updates the server loading information according to the plurality of pieces of server information.

9. The SDN system of claim 7, wherein the first switch transceiving unit further receives a second client network packet from the client device, and the first switch processing unit further transmits the second client network packet to the first server among the servers via the first switch transceiving unit according to the connection route.

10. The SDN system of claim 7, wherein the first SDN switch and the servers belong to a same Local Area Network (LAN) domain, the first client network packet comprises a client start IP address, the controller processing unit further determines the connection route of the client device according to the client start IP address of the first client network packet and the server loading information, the connection route records a correspondence relationship of the client start IP address with a first MAC address and a first connection port, and the first switch processing unit transmits the first client network packet to a first server among the servers via the first switch transceiving unit according to the correspondence relationship recorded in the connection route.

11. The SDN system of claim 10, wherein the first switch transceiving unit further receives a second client network packet from the client device, the second client network packet comprises the client start IP address, and the first switch processing unit further directly transmits the second client network packet to the first server among the servers via the first switch transceiving unit according to the correspondence relationship of the connection route.

12. The SDN system of claim 7, further comprising:
a second SDN switch connecting to the SDN controller and comprising:
a second switch processing unit;
a second switch transceiving unit; and
a second switch storage unit; and
a third SDN switch connecting to the SDN controller and comprising:
a third switch processing unit;
a third switch transceiving unit; and
a third switch storage unit;
wherein the first SDN switch connects to the servers via the second SDN switch and the third SDN switch, the first SDN switch, the second SDN switch and the third SDN switch belong to a same LAN domain, the first SDN switch and the servers belong to different LAN domains from each other, the first client network packet comprises a client start IP address, the controller processing unit further determines the connection route of the client device according to the client start IP address of the first client network packet and the server loading information, the connection route records a first correspondence relationship of the client start IP address with a first connection port of the second SDN switch, a second correspondence relationship between an LAN IP address translation rule corresponding to the client start IP address and a second connection port of the third SDN switch, and a third correspondence relationship of the client start IP address with a first MAC address of the first server and a third connection port, the controller transceiving unit further transmits the first correspondence relationship, the second correspondence and the third correspondence relationship of the connection route to the first SDN switch, the second SDN switch and the third SDN switch respectively, the first switch storage unit further stores the first correspondence relationship, the first switch processing unit further transmits the first client network packet to the second SDN switch via the first switch transceiving unit according to the first correspondence relationship, the second switch storage unit stores the second correspondence relationship, the second switch processing unit translates a client destination IP address of the first client network packet into a server IP address shared by the servers according to the LAN IP address translation rule of the second correspondence relationship and transmits the first client network packet to the third SDN switch via the second switch transceiving unit, the third switch storage unit stores the third correspondence relationship, and the third switch processing unit transmits the first client network packet to the first server among the servers via the third switch transceiving unit according to the third correspondence relationship and the server IP address.
